(19) United States
(12) Patent Application Publication
(10) Pub. No.: US 2010/0178026 A1
(43) Pub. Date: Jul. 15, 2010

(54) Video Recording And Playback Device, Video Recording Device And Video Encoding Device

(75) Inventor: Shuji OGASAWARA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/731,673

(22) Filed: Mar. 25, 2010

Related U.S. Application Data
(63) Continuation-in-part of application No. PCT/JP2008/067554, filed on Sep. 26, 2008.

(30) Foreign Application Priority Data
Sep. 28, 2007 (JP) 2007-256192
Sep. 19, 2008 (JP) 2008-241185

(51) Int. Cl. H04N 5/91; H04N 7/26

(52) U.S. Cl. 386/66; 386/112; 386/E05.003

(57) ABSTRACT

A video recording and playback device that simultaneously executes a recording process that encodes video information and records to a recording medium, as well as a playback process that decodes the video information and reproduces the video information is disclosed. The device includes an encoding processing unit for encoding the video information to be recorded on the recording medium and a bit rate directing unit instructing the encoding bit rate of the video information as a first bit rate. The encoding processing unit encodes the video information in a second bit rate which is higher than a first bit rate, before encoding the video information in the first bit rate.

### CROSS-REFERENCE TO RELATED APPLICATIONS

This application is a continuation-in part application of International Pat. App. No. PCT/JP2008/067554, filed on Sep. 26, 2008, which claims priority to Japanese patent applications JP2007-256192, filed on Sep. 28, 2007, and JP2008-241185, filed on Sep. 19, 2008), each of which applications are hereby incorporated by reference herein.

### TECHNICAL FIELD

The present invention relates to a video recording and playback device achieving a “follow-up replay” which simultaneously executes a recording process, encoding video information and recording the information on a recording medium, and a playback process, decoding the video information recorded on the recording medium and playback the information.

### BACKGROUND ART

In recent years, a video recording and playback device realized by a hard disc recorder having a “follow-up replay” function is seen in the market. The follow-up replay is a function replaying a video information (TV program etc.) while recording the video information on a media such as hard disk or DVD (Digital Versatile Disc) (for example, see JP 2003-179845A). According to this function, a user can watch the TV program from the beginning while recording the program without waiting until the end. Further, the user can record the program while leaving the room for a short time, and then can watch the program immediately after returning to the room.

In these devices, the video data is controlled to be stored more than a predetermined capacity in a buffer memory so that the reproduction does not halt due to a fluctuation of the bit rate.

Accordingly, the follow-up replay is disabled until the predetermined video data is stored in the buffer memory (or a recording medium). Thus, the user should wait awhile for the follow-up replay when he or she began recording (usually, it takes about couple 10 seconds). For example, when a user record (take a snapshot of) a TV screen where a telephone number is displayed (such as a TV shopping program), the user should wait for couple 10 seconds to replay the recorded TV screen.

Therefore, in order to solve this problem, it may be effective to enable the follow-up replay even when a video data written in the buffer memory is less than the above-mentioned capacity. However, in this case, since a frequent access to the recording medium is necessary, it reduces the recording or playback efficiency.

### SUMMARY

One of a present invention regards to a video recording and playback device simultaneously executing a recording process which encodes video information and records to a recording medium, and a playback process which decodes the video information and reproduces the information, comprising: an encoding processing unit encoding the video information to be recorded on the recording medium; and a bit rate directing unit instructing the encoding bit rate of the video information as a first bit rate, wherein the encoding processing unit encodes the information in the second bit rate which is higher than the first bit rate, before encoding the information in the first bit rate.

Here, the video information includes not only a format having video data only, but also a format having both video data and audio data. The encoding includes not only a process compressing a non-compressed video image data to the MPEG (Moving Picture Experts Group) format but also a transcoding process (such as conversion of encoding format or conversion of compressing zone).

One of a present invention regards to a video recording device executing a process which encodes video information and records to a recording medium, comprising: an encoding processing unit encoding the video information to be recorded on the recording medium; a bit rate directing unit instructing the bit rate of the video information to be encoded and recorded to the recording medium; a control unit controlling the encoding bit rate of the video data on the encoding processing unit, wherein the control unit controls the encoding processing unit so that, before the video data is encoded in the first bit rate instructed by the directing unit, the video data is encoded in the second bit rate which is higher than the first bit rate.

One of a present invention regards to a server device which encodes video information and stores to a recording medium as well as transmitting the stored video information to the external device, comprising: an encoding processing unit encoding the video information to be recorded on the recording medium; a bit rate directing unit instructing the bit rate of the video information to be encoded and recorded to the recording medium; a control unit controlling the encoding bit rate of the video data on the encoding processing unit, a readout unit reading the video information designated from the external device via network, and the transmitting unit transmitting the video information read from the recording medium, wherein the control unit controls the encoding processing unit so that, before the video data is encoded in the first bit rate instructed by the directing unit, the video data is encoded in the second bit rate which is higher than the first bit rate.

One of the present invention relates to a video encoding device executing a process which encodes video information recorded on a recording medium, comprising: an encoding processing unit encoding the video information read out from the recording medium; and a bit rate directing unit instructing the bit rate, when playing back the video information, as a first bit rate, wherein the encoding processing unit encodes the video data in the second bit rate which is higher than the first bit rate data, before encoding the video data in the first bit rate. The image information recorded on the recording medium is encoded one, and the coding processing unit re-encodes the video data after decoding the video data. Further, a complete decoding is not necessary for re-encoding (such as transcoding or bit rate conversion).

One of a present invention regards to a server device which encodes video information and stores to a recording medium as well as transmitting the stored video information to the external device, comprising: a read out unit reading out a video data which is directed from an external device via network; an encoding processing unit encoding the video information read out from the recording medium; a bit rate directing unit instructing the bit rate of the video information when playback; a control unit controlling the encoding bit rate of the video data on the encoding processing unit, and the transmitting unit transmitting the video information read from the recording medium, wherein the control unit controls the encoding processing unit so that, before the video data is encoded in the first bit rate instructed by the directing unit, the video data is encoded in the second bit rate which is higher than the first bit rate.

One of the present invention regards to a video encoding device executing a process which encodes video information and records to a recording medium, comprising: an encoding processing unit encoding the video information; and a bit rate directing unit instructing the bit rate of the video information, when recording to the recording medium, as a first bit rate, wherein the encoding processing unit encodes the video data in the second bit rate which is higher than the first bit rate data before encoding the data in the first bit rate.

One of the present invention regards to a client device which encodes video information and transmits to a server device, comprising: an encoding processing unit encoding the video information; a bit rate directing unit instructing the bit rate of the video information; and a control unit controlling a bit rate when the encoding processing unit encodes the video information, wherein the controlling unit controls the encoding processing unit so that, before encoding the information in the first bit rate which is directed from the directing unit, the information is encoded in the second bit rate which is higher than the first bit.

### BRIEF DESCRIPTION OF THE DRAWINGS

FIG. 1 is a figure showing a configuration of a video recording and playback device 100 which can receive an analog broadcasting television signal.

FIG. 2 is a figure showing a time chart of recording.

FIG. 3 is a figure showing a necessary time until the follow-up display becomes possible.

FIG. 4 is a figure showing a configuration of a video recording and playback device 100 which receives a digital terrestrial broadcasting television signal.

FIG. 5 is a figure showing compositions of a server storing the video information, a client device offering the video information to the server, and a system where video information is distributed from the server.

FIG. 6 is a figure showing a configuration of a client device 350.

FIG. 7 is a figure showing a configuration of a server 300.

FIG. 8 is a figure showing a configuration of a client device 360.

FIG. 9 is a figure showing a configuration of a server 400.

FIG. 10 is a figure showing a configuration of a client device 550.

FIG. 11 is a figure showing a configuration of a server 500.

### DETAILED DESCRIPTION

### First Embodiment

An embodiment of the video recording and playback device 100 of the present invention is described below.

### (Configuration of the Video Recording and Playback Device 100)

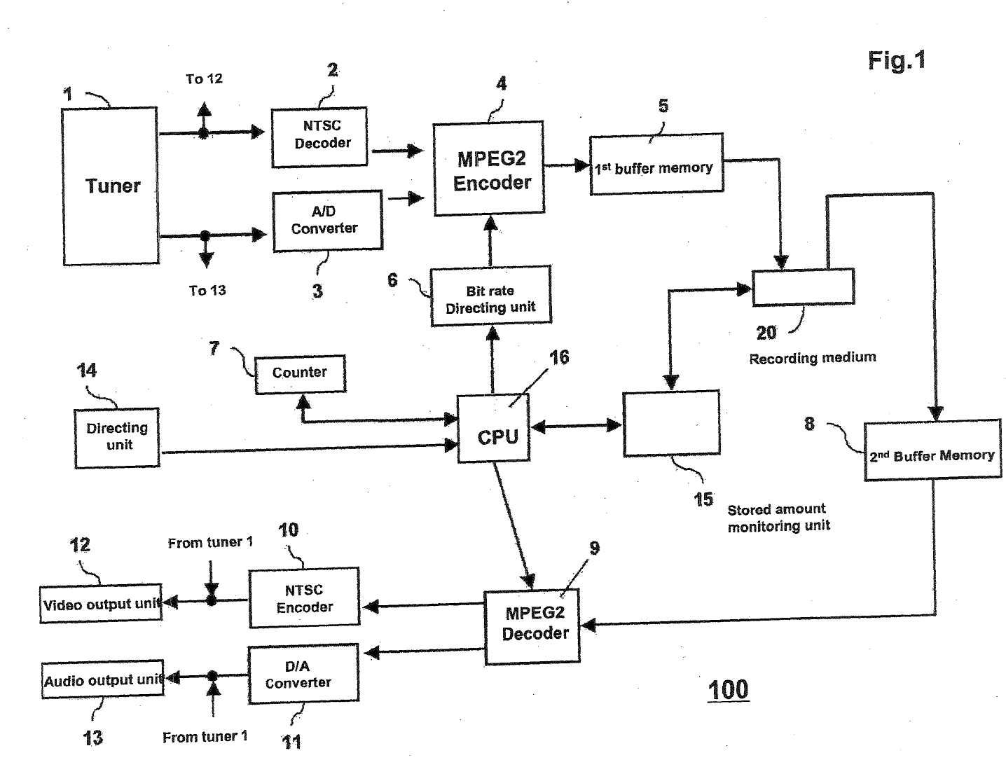

FIG. 1 is a figure showing a configuration of a video recording and playback device 100 which receives an analog broadcasting television signal. The device 100 has a tuner 1, a NTSC decoder 2, an A/D converter 3, a MPEG-2 encoder 4, a first buffer memory 5, a bit rate directing unit 6, a counter 7, a second buffer memory 8, a MPEG-2 decoder 9, a NTSC encoder 10, a D/A converter 11, an video output unit 12, an audio output unit 13, a directing unit 14, a stored amount monitoring unit 15, CPU (Central Processing Unit) 16, and a recording medium 20. The unit 6, the counter 7, the unit 15, and CPU 16 function as a control unit of the device 100.

The tuner 1 outputs a video or audio signal of a selected channel among an analog terrestrial broadcasting television signal or analog satellite broadcasting television signal received by an antenna (not illustrated). The NTSC decoder 2 removes synchronization signal etc. from an analog NTSC (National Television Standards Committee) video signal output from the tuner 1 and extracts the video data portion from the signal. Further, the decoder 2 converts the signal into a digital video signal (video information) by quantization and sampling. The A/D converter 3 converts an analog audio signal output from the tuner 1 to a digital audio signal by quantization and sampling.

The MPEG-2 encoder 4 converts a video signal output from the NTSC decoder 2 to a MPEG-2 encoded signal. Further, the encoder 4 converts an audio signal output from the A/D converter 3 to a MPEG-Audio format signal.

The first buffer memory 5 is a semiconductor memory prepared between the MPEG-2 encoder 4 and the recording medium 20. The memory 5 temporarily stores a data for compensating the difference of processing speed of the encoder 4, and recording speed to the medium 20. The bit rate directing unit 6 directs the encoding bit rate in the encoder 4.

The counter 7 measures a time. For example, it measures a time elapsed from an instruction input from the directing unit 14.

The recording medium 20 is medium, such as hard disk, DVD, or semiconductor memory.

The second buffer memory 8 is a semiconductor memory prepared between the recording medium 20 and the MPEG-2 decoder 9, and temporarily stores data for compensating the difference between read-out speed from the medium 20, and processing speed of the decoder 9. Further, the memory 7 is controlled to store more than a predetermined amount of video data so that the video data does not halt due to bit rate fluctuations etc. In other words, the device 100 is constituted so that the decoding in the decoder 9 is inhibited until a predetermined amount of data is stored to the memory 8, and the video data recorded in the medium 20 can not be reproduced. Hereafter the predetermined amount is called “RBA” (Required Buffer Amount“).

The MPEG-2 decoder 9 demultiplexs the signal read from the recording medium 20 into video signal and audio signal, and decodes each of the demultiplexed signals. The NTSC encoder 10 converts the video signal output from the decoder 9 to a NTSC format signal. The D/A converter 11 convert a digital audio signal output from the decoder 9 to an analog audio signal.

The video output unit 12 outputs the NTSC signal output from the NTSC encoder 10. The audio output unit 13 outputs the analog audio signal output from the D/A converter 11. Further, the unit 12 and 13 corresponds to the external output terminal if the device 100 is a HDD recorder, and corresponds to a display unit and a speaker respectively when the device 100 is a television set.

The directing unit 14 is constituted by remote controller or operating keys, and receives instructions from the user. The instruction from the unit 14 may be the one setup beforehand by a user using a timer recording function.

The CPU 16 recognizes the input from the directing unit 14, or controls the bit rate directing unit 6 and the counter 7 based on an input from the directing unit 14. Further, the CPU 16 controls each part of the device 100.

The configuration of the video recording and playback device 100 is as explained above. Further, the bit rate of the video signal decoded by the NTSC decoder 2 is higher than the bit rate of the data output from the MPEG-2 encoder 4. When displaying received analog television broadcasting from the video output unit 12, the video signal output from the tuner 1 is output to the unit 12 directly, and audio signal is output to the audio output unit 13 directly.

### (Recording Process)

The above-mentioned device 100 performs a recording process according to a recording direction from the directing unit 14. The recording process is explained below.

The device 100 can achieve a recording process of normal mode and the process of special mode. The normal mode is the recording process generally realized by HDD recorder etc. in the market and records contents (such as television broadcasting program) by a first bit rate instructed from the directing unit 14. In the special mode, the recording is achieved by a second bit rate, which is larger than the first rate, at the beginning of the recording, and then switches to the first bit rate.

As mentioned above, in the device 100, during the video reproduction, the decoding in the MPEG-2 decoder 9 is inhibited and the video data recorded on the recording medium 20 cannot be reproduced until the data of RBA is buffered to the second buffer memory 8. Thus, in order to achieve the follow-up replay, video data more then the RBA should be recorded on the recording medium 20 at least.

In the above-mentioned special mode the recording is performed at a high speed until the predetermined amount of data is recorded on the recording medium 20. Thereby, the data can be read out in high speed after the start of replay, and the data is accumulated quickly to the memory 8. Accordingly, it can shorten the time for enabling the follow-up replay from the time the recording started.

Further, when a data amount reaches the predetermined amount, the recording is performed by switching to the first bit rate. Thereby, it can save the capacity of the recording medium. When a user aims a quick realization of follow-up replay rather than high quality videos, the high bit rate recording is no more necessary after the time when the follow-up replay becomes possible. Therefore, the recording capacity of the recording medium 20 is saved by lowering the recording bit rate to the first rate.

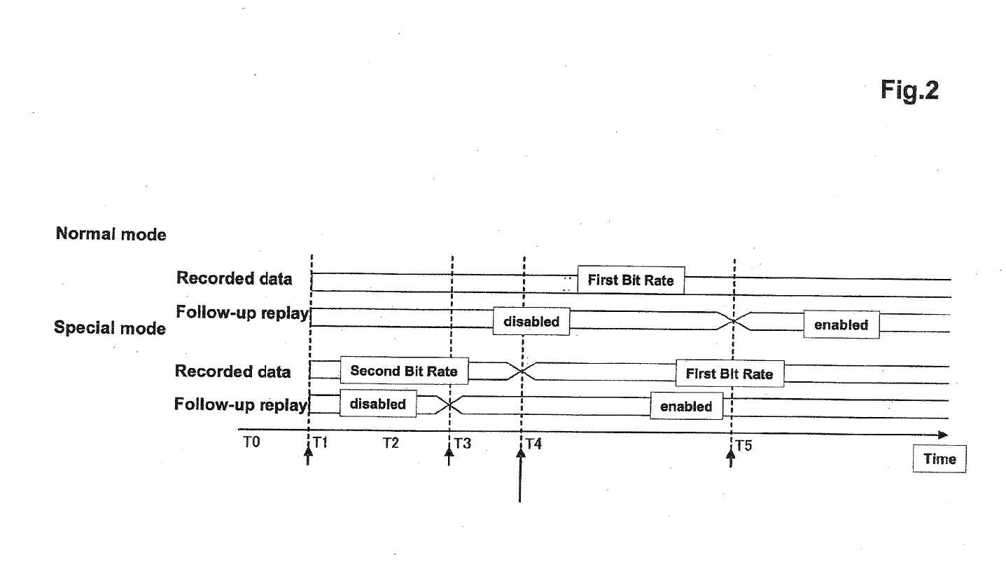

Referring to a time chart of FIG. 2, the detail of recording process is explained. When a normal mode recording direction from the directing unit 14 is input in time T1, the bit rate directing unit 6 directs the MPEG-2 encoder 4 to encode in the first bit rate instructed from the unit 14. Receiving the direction, the CPU 16 makes the stored amount monitoring unit 15 monitor the amount of video data stored to the recording medium 20 from this time.

On the other hand, when there is a special mode recording direction from the unit 14 in time T1, the unit 6 directs the MPEG-2 encoder 4 to encode with (instead of first bit rate directed from the unit 14) the second bit rate which is higher than the first rate. Receiving the direction, the CPU 16 makes the unit 15 to monitor the amount of video data stored to the medium 20 from this time.

At the time T1, there is no data stored in the medium 20, since it is the time where the recording is started. At the time T2, where the time of T2-T1 has elapsed after the recording start, there is some recorded data in the medium 20.

From a time point where CPU 16 has recognized that the data recorded to the medium 20 reached RBA, follow-up replay is enabled (in time chart of FIG. 2, this time point is described as T3).

As described above, in the device 100, decoding by the MPEG-2 decoder 9 is suppressed until the data of RBA is buffered by the second buffer memory 8. In order to buffer RBA data in the memory 8, the video data more than RBA should be stored to the recording medium 20 at least, and this time point corresponds to T3. After the video data of RBA is stored to the media 20 (which is after time T4), the bit rate directing unit 6 directs the MPEG-2 encoder 4 to encode with the first bit rate instructed from the directing unit 14.

On the other hand, when recorded by the normal mode, since the recording bit rate is low, the data stored in the recording medium 20 at time T3 is under RBA. At time T5, where a certain time has elapsed from T3, the amount of data stored is equal to RBA, and thus the follow-up replay is enabled. Thus, in the normal mode, the time necessary for enabling the follow-up replay is larger by T5-T3 than the special mode. In other words, follow-up replay is enabled quickly in the special mode by T5-T3, compared to the normal mode.

### (Follow-Up Replay)

When a “follow-up replay” to a content currently recording is instructed from the directing unit 14, the CPU 16 makes the stored amount monitoring unit 15 to check whether the data amount stored to the recording medium 20 has reached RBA.

If the data amount monitored by the unit 15 reaches RBA, the CPU 16 directs the MPEG-2 decoder 9 to decode the data read from the recording medium 20. The decoded video signal is encoded by the NTSC encoder 10, and transmitted to the video output unit 12. The decoded audio signal is converted into analog signal by D/A converter 11, and transmitted to the audio output unit 13. Thus, the follow-up replay is performed.

On the other hand, if the data amount monitored by the unit 15 has not reached RBA yet, the CPU 16 directs the MPEG-2 decoder 9 to inhibit the decoding to the data read from the medium 20. Thus, the follow-up replay is disabled.

When instructed a follow-up replay from the directing unit 14, the CPU 16 may make the counter 7 to check if the time elapsed since the recording instruction from the unit 14 is more than the predetermined time.

In this case, if the time measured by the counter 7 reaches the predetermined time, the CPU 16 directs the MPEG-2 decoder 9 to decode the data read from the recording medium 20. The decoded video signal is encoded by the NTSC encoder 10 and is transmitted to the video output unit 12. The decoded audio signal is converted into analog signal by D/A converter 11, and transmitted to the audio output unit 13. Thus, the follow-up replay is performed.

If the time measured by the counter 7 has not reached the predetermined time, the CPU 16 directs the MPEG-2 decoder 9 to inhibit the decoding of the data read from the recording medium 20. Thus, the follow-up replay is disabled.

### (Time Shortened for Enabling the “Follow-Up Replay”)

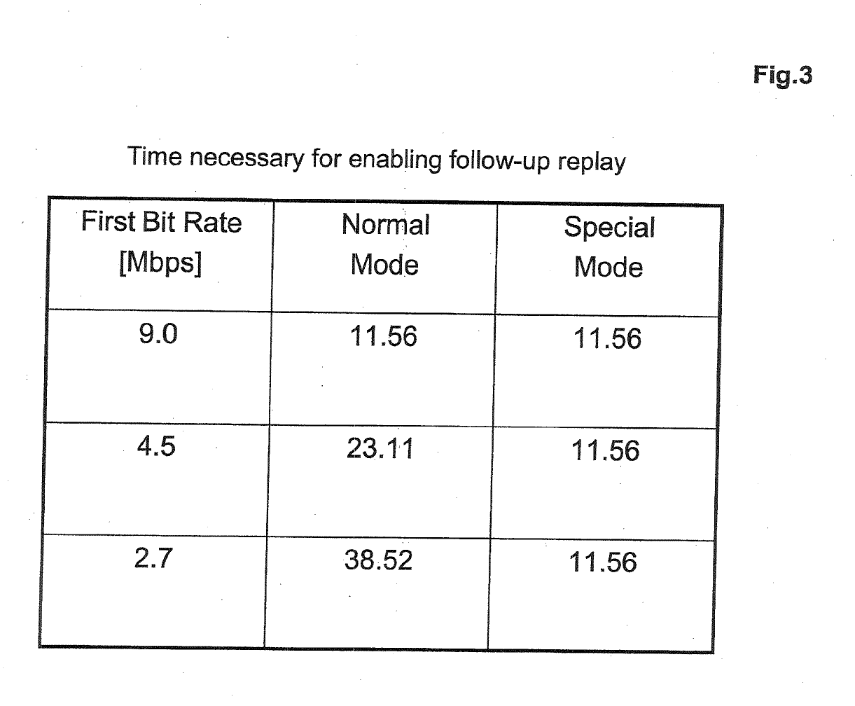

FIG. 3 shows a time necessary for enabling the follow-up replay from the recording start, when by normal mode and special mode. Here, the video recording and playback device is assumed that it can direct three kinds of bit rate (9.0 Mbps, 4.5 Mbps, and 2.7 Mbps). Here, RBA is assumed to be 13 Mbytes and the bit rate in the special mode at the beginning of the recording (which is the “second bit rate”) is assumed to be 9.0 Mbps.

The “first bit rate” in the figure indicates a bit rate directed from the directing unit 14. If the first bit rate is 2.7 Mbps for example, the recording is performed with 2.7 Mbps from the beginning to end in the normal mode. In the special mode, until the time follow-up replay is enabled, the recording is performed by 9.0 Mbps, and the recording is switched to 2.7 Mbps after the time when the follow-up replay is enabled.

In the normal mode, the follow-up replay is disabled for 39 seconds from the recording start when the first bit rate is 2.7 Mbps. On the other hand, in the special mode, the follow-up replay is enabled in only 12 seconds from the recording start, because the encoding is performed in 9.0 Mbps in the beginning of the recording.

In the normal mode, the follow-up replay is disabled for 23 seconds from the recording start, when the first bit rate is 4.5 Mbps. In the special mode, the follow-up replay is enabled in 12 seconds because the encoding is performed in 9.0 Mbps in the beginning of the recording.

When the first bit rate is 9.0 Mbps, the time necessary for enabling the follow-up replay is the same for the normal mode and the special mode. In both modes, the follow-up relay is enabled in 12 seconds.

According to the special mode of present embodiment, since the recording is performed in a high bit rate in the beginning of the recording, it can shorten the time for enabling the follow-up replay while preventing the increase in storage capacity.

### (Video Recording and Playback Device 200 Receiving Digital Broadcast Signals)

On the above, the device 100 receiving an analog broadcasting television signal above is explained. However, the present invention can be adapted to the device 200 receiving digital terrestrial broadcasting television signal as well.

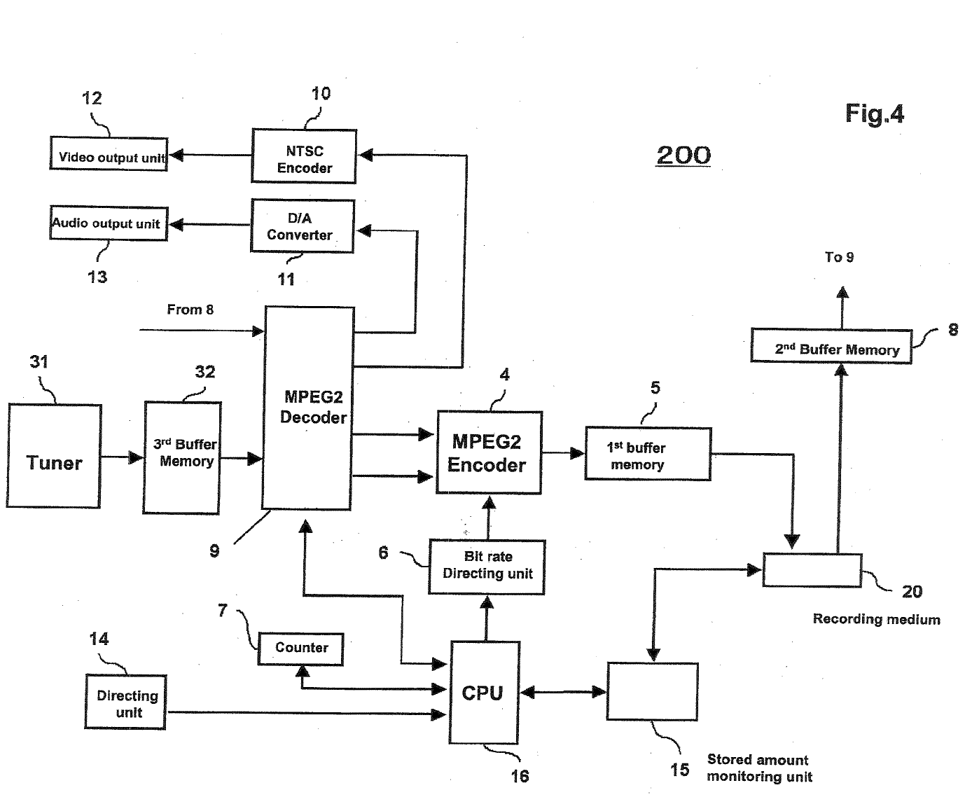

FIG. 4 is a functional block diagram of the device 200. For the block which has the same function as in the device 100, the same symbol is allotted.

Acquiring a digital terrestrial broadcasting television signal received by the antenna (which is not illustrated) or a digital satellite broadcasting television signal, the tuner 31 outputs a video signal and an audio signal of the channel which is tuned. The MPEG-2 decoder 9 decodes the signal output from the tuner 31. The third buffer memory 32 is formed between the tuner 31 and the decoder 9, and stores data temporarily, to compensate the difference between the fluctuating bit rate of digital broadcasting television signal and the processing speed (processing bit rate) of the decoder 9.

The video signal decoded by the decoder 9 is converted to a NTSC format signal by the NTSC encoder 10, and is output to the video output unit 12. When the unit 12 is a display, video image is output from the unit 12. Similarly, the audio signal decoded by the decoder 9 is converted to an analog signal by D/A converter 11, and is output to the audio output unit 13.

When instructed a recording from the directing unit 14, the MPEG-2 encoder 4 encodes video signal and audio signal decoded by the MPEG-2 decoder 9. The encoded signal is recorded on the recording medium 20 via the first buffer memory 5. The encoding bit rate in the encoder 4 is controlled by a similar method as the device 1, and it is performed by the bit rate directing unit 6, the counter 7, and the CPU 16.

### (Trace-Back Replay)

The present invention can be applied to a “Trace-back Replay” as well. The trace-back replay is a function applicable in both of the device 100 and the device 200 described above. In this function, when there is a direction from a user to record a video currently displayed in the video output unit 12, the data before the direction from the user is recorded as well. Thus the video data which is displayed before the recording instruction can be replayed as well.

Its procedure is explained taking the device 100 as an example. In the embodiment of the follow-up replay explained above, the MPEG-2 encoder 4 encodes the video signal in response to a recording direction from the directing unit 14. In this embodiment, the encoder 4 encodes the video signal received by the tuner 1 irrespective of the existence of the recording directions from the unit 14. The encoded video signal is stored in the first buffer memory 5. Trigged by a recording direction from the unit 14, the video signal stored in the memory 5 is recorded on the recording medium 20. When there are no recording directions from the unit 14, the video signal encoded by the encoder 4 is discarded from the old data when the capacity of the memory 5 is filled.

If the encoding of the video signal is performed in a high bit rate (for example, in the “second bit rate” as mentioned above) by the MPEG-2 encoder 4, it can shorten the time for enabling the trace-back replay from the time the tuner 1 start receiving a data.

It is possible to perform the trace-back replay as well as in the device 200, by operating the MPEG-2 encoder 4, the first buffer memory 5, as well as in the device 100.

### (Modification)

Instead of MPEG-2 encoder or decoder, depending on the encoded format of the broadcasting signal or the recording signal to the recording medium, H.264 encoder/decoder, or VC-1 encoder/decoder may be used.

In the device 200, a bit rate conversion is performed by a decoding in the MPEG-2 decoder 9, and the encoding in the MPEG-2 encoder 4. Instead, the conversion may be performed using a transcoder.

In the above-mentioned embodiment, the follow-up replay is explained as replaying the contents once recorded on the recording medium 20. Instead, it may replay the contents temporarily memorized in the video buffer before recording it on the recording medium 20.

In the above-mentioned embodiment, it is recorded in a high bit rate (the second bit rate) in the beginning of the recording, and then switches to a normal bit rate (the first bit rate). However, when thus recorded data is reproduced, the quality of the video suddenly deteriorates from a certain time point, and the user may feel uncomfortable. Therefore, instead of changing the recording bit rate stepwise, it may be lowered gradually.

In the above-mentioned embodiment, though it is switched to the first bit rate when the video data stored reached the predetermined amount, instead it may be switched to the first bit rate when a predetermined time has elapsed from a recording direction. In detail, the CPU 16 let the counter 7 measure the time and let the bit rate directing unit 6 encode in the second bit rate after receiving the recording direction. Then, when the predetermined time has elapsed since the counter 7 starts the measuring, it may let the unit 6 encode in the first bit rate.

In the above-mentioned embodiment, the buffer memories 5 and 8 are constituted by semiconductor memory, but its function may be achieved by a buffer space prepared on the recording medium 20(HDD).

In the above-mentioned embodiment, the follow-up replay is enabled when the video data stored in the recording medium 20 reaches RBA. Instead, the threshold value may be other than RBA.

### The Second Embodiment

### System Configuration

The first embodiment regards to a video recording and playback device which receives a broadcasting signal and records the signal, and it is an example of the present invention applied to hard disc recorder or DVD recorder for home use. The present invention can be applied to a server, which provides a user with video information by networks such as internet.

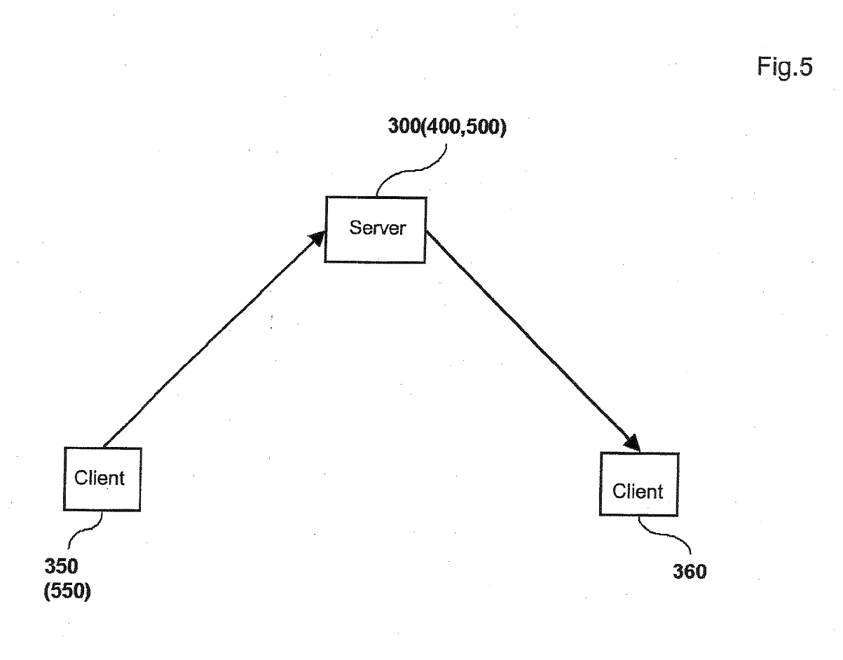

Referring to FIG. 5, first, a client device 350 transmits (uploads) video information to the server 300 in this embodiment. The transmitted information is stored in the recording device of the server 300. The information stored in the server 300 is transmitted (distributed) to the client device 360 according to a demand from the device 360.

### (Configuration of the Client Device 350)

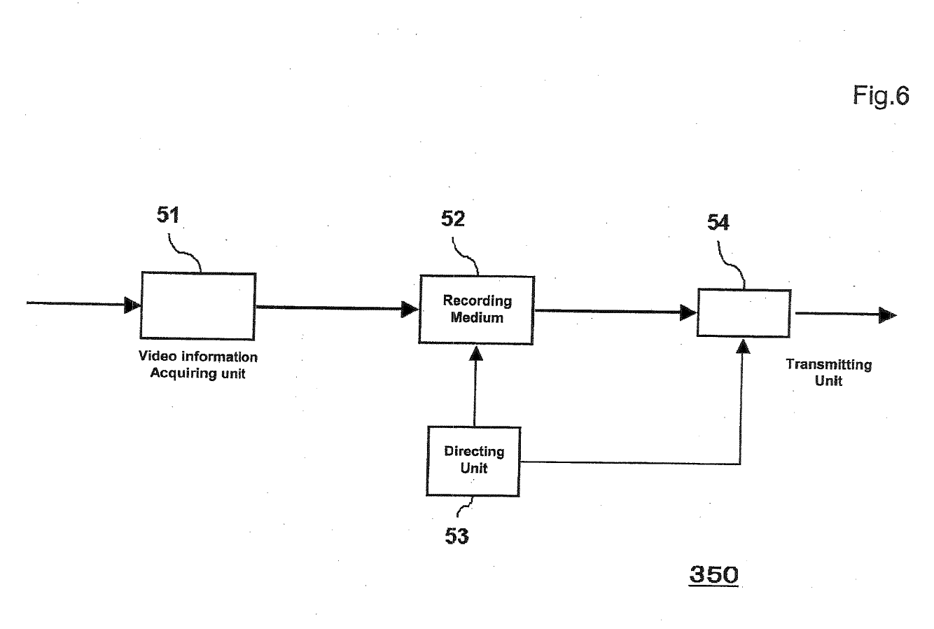

Referring to FIG. 6, the client device 350 has video information acquiring unit 51, a storing medium 52, a directing unit 53, and a transmitting unit 54.

The video information acquiring unit 51 acquires video information from an external device. For example, it acquires video information captured by video camera. The storage medium 52 is a recording medium such as hard disk, and memorizes the video information acquired by the unit 51. The directing unit 53 is constituted by a remote controller or operating keys, and receives directions from the user. The transmitting unit 54 transmits video information etc. out to networks such as Ethernet.

Instead of the above-mentioned, the video information acquiring unit 51 may be constituted by a tuner receiving a broadcasting wave and may acquire video information from the broadcast. The unit 51 may be constituted by a device which reproduces recording mediums such as hard disk and digital versatile disc, and may acquire video information from these mediums.

The video information acquired by the unit 51 may be transmitted out to network from the transmitting unit 54, without memorizing the information temporarily on the storage medium 52.

### (Configuration of the Server 300)

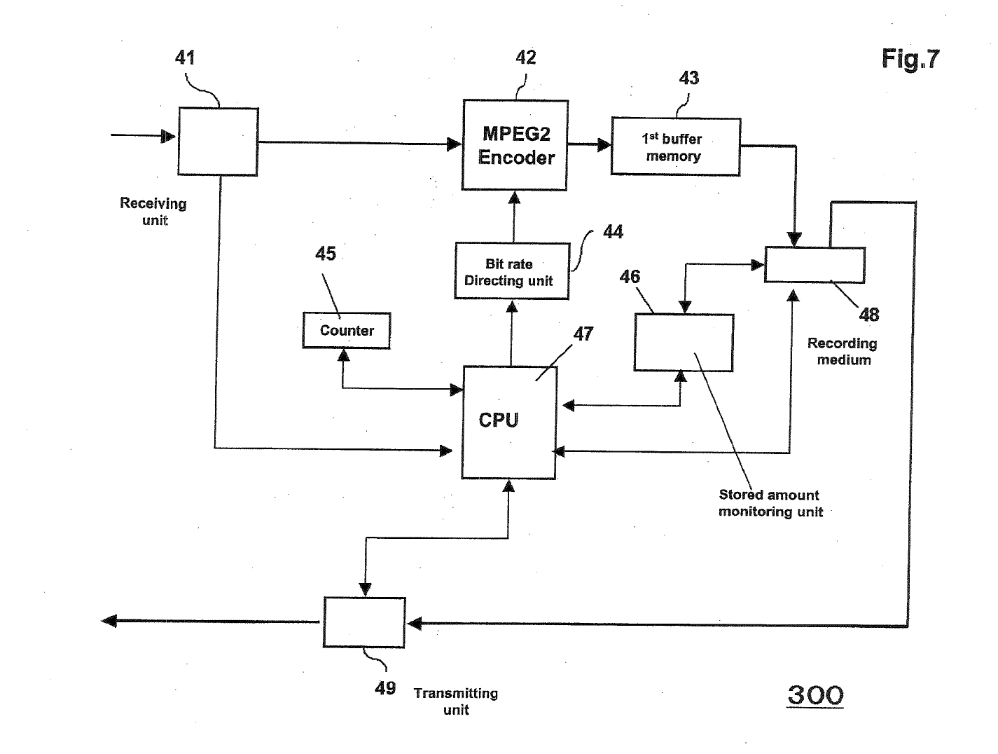

Referring to FIG. 7, a server 300 has a receiving unit 41, a MPEG-2 encoder 42, a first buffer memory 43, a bit rate directing unit 44, a counter 45, a stored amount monitoring unit 46, a CPU 47, a recording medium 48, and a transmitting unit 49.

The receiving unit 41 receives video information etc. from networks such as Ethernet (registered trademark in Japan). The MPEG-2 encoder 42 performs a bit rate conversion to the video information signal received by the unit 41 according to a direction from the bit rate directing unit 44.

The first buffer memory 43 is a semiconductor memory prepared between the MPEG-2 encoder 42 and the recording medium 48, and stores a data temporarily in order to compensate the difference of the processing speed of the encoder 42 and the recording speed to the medium 48. The unit 44 instructs the encoder 42 to change the bit rate.

The counter 45 measures time. For example, it measures the time elapsed since the receiving unit 41 receive the video information. The stored amount monitoring unit 46 monitors the amount of data recorded to the recording medium 44.

CPU 47 performs a process such as recognizing the receiving unit 41 receiving video information signals, controlling the bit rate directing unit 44 and the counter 45, or controlling each part of the server 300.

The recording medium 48 is hard disk etc. and stores video information transmitted from client devices. Since it is necessary to store a lot of information, the medium 48 may be consisted by plurality of hard disks. The transmitting unit 49 transmits video information etc. out to a network.

### (Configuration of the Client Device 360)

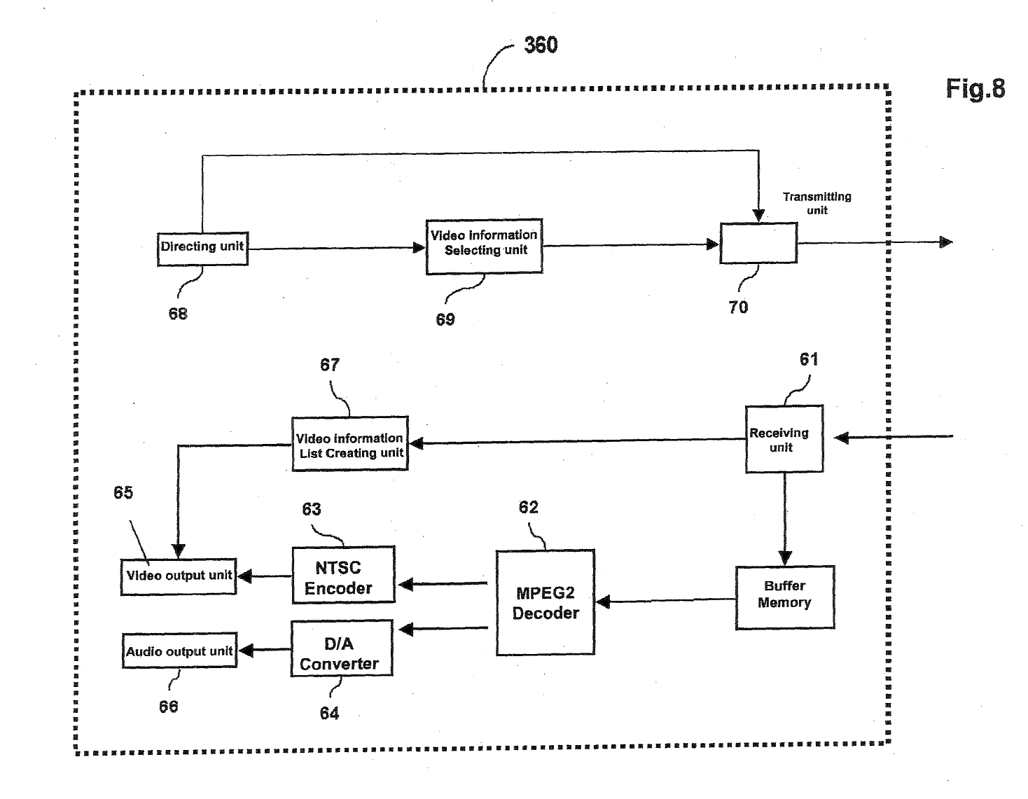

Referring to FIG. 8, the client device 360 has a receiving unit 61, a MPEG-2 decoder 62, a NTSC encoder 63, a D/A converter 64, a video output unit 65, an audio output unit 66, a video information list creating unit 67, a directing unit 68, a video information selecting unit 69, and the transmitting unit 70.

The receiving unit 61 receives video information etc. from networks such as Ethernet. The MPEG-2 decoder 62 demultiplexs the information the unit 61 received into a video signal and an audio signal, and decodes the respective signal. The NTSC encoder 63 converts a video signal output from the decoder 62 to the NTSC format signal. D/A converter 64 converts the digital signal output from the decoder 62 into an analog audio signal. The video output unit 65 outputs the NTSC signal output from the encoder 63. The audio output unit 66 outputs the analog audio signal output from the converter 64. As well as the device 100, the units 65 and 66 correspond to external output terminals when the video recording and playback device is a HDD recorder, and corresponds to a display unit and a speaker respectively, when the device is a television set.

The video information list creating unit 67 creates a list of the video information which the server 300 stores, and outputs it to the video output unit 65. In detail, when the receiving unit 61 receives a signal from the server 300, the unit 67 analyzes the signal and investigates whether the signal includes a list data showing the video information the server 300 currently stores. If the list data is included, the unit 67 converts a format of the signal so that the video output unit 65 can display the list data.

The directing unit 68 is constituted by remote controller or by operating key and receives directions from the user. The video information selecting unit 69 selects the video information based on the instruction from the unit 68. The transmitting unit 70 transmits a video information requesting signal to the server 300 via network according to the selection made by the unit 69.

### (Upload Process)

An example of uploading process of video information from the client device 350 to server 300 is explained below.

When a user of client device 350 uploads video information to the server 300, the user instructs from the directing unit 53 to transmit the information to the server 300. The video information transmitted from the device 350 is stored in the recording medium 48 of the server 300.

The server 300 records a data to the recording medium 48 in a second bit rate, which is higher than the predetermined first bit rate, right after receiving a video information from the client device 350, and when the recorded data amount exceeds the predetermined amount, it performs a recording by switching the rate to the first bit rate. Here, the predetermined amount is equivalent to RBA described in the first embodiment. Thus, upload processing from the device 350 to server 300 is performed.

### (Distributing Process)

Here, an example of a process distributing the video information stored in the server 300 to the client device 360, and playing back the information in the device 360 are explained.

When a user of the client device 360 downloads (receives) video information from the server 300, the user operates the directing unit 68 and directs to acquire the list of video information the server 300 currently stores. The direction is transmitted from the transmitting unit 70 to the server 300 as a demand signal. When the demand signal is received, the CPU of the server 300 searches the recording medium 48, and acquires a list data of the video information the medium 48 stores. The list data is then transmitted to the device 360.

When the receiving unit 61 of the client device 360 receives the list data, the video information list creating unit 67 converts the list data so that the display output unit 65 of the device 360 can display. Thereby, the list is displayed to the display unit of the client device 360.

When a user, who looked at the list displayed on the display unit, downloads video information, the user directs from the directing unit 68 to acquire the video information from the server 300. A signal input from the unit 68 (for example an input signal from a mouse device) is converted into a signal which the server 300 can understand by the unit 69 (i.e. a signal for demanding to transmit a specified video information), and then transmitted from the transmitting unit 70.

When the receiving unit of the server 300 receives this demand signal, the CPU of the server 300 reads the demanded video information data from the recording medium 48. Since the information data is recorded in the second bit rate in the beginning portion of the information, and the latter part of the information is recorded in the first bit rate (here, the second bit rate is higher than the first bit rate), the beginning portion is read out in the second bit rate and the latter part is read out in the first bit rate. The read out video information data is controlled so that the data is transmitted to client device 360 via transmitting unit 49.

When the receiving unit 61 of the device 360 receives this video information, each of the video signal and the audio signal is decoded in MPEG-2 decoder 62. The video signal is output from the video output unit 65 via NTSC encoder 63. The audio signal is output from the audio output unit 66 via D/A converter 64.

As mentioned above, the server 300 records in a bit rate higher than the predetermined rate right after receiving video information. Thereby, the client device 360 can reproduce video information in a short time after demanding the video information to the server 300.

It takes a long time until the buffer memory to store the predetermined amount of data when the video information received by the client device 360 has a low bit rate, and thus it takes long time until the video is displayed in the display unit after the device 360 start receiving the data. Therefore, by recording a data in the medium 48 of the server 360 by a second bit rate which is higher than the predetermined bit rate in the beginning, the data can be read out in the second bit rate from the beginning as well, and thus it can shorten the time for displaying video since the start of the playback in the client device 360.

### The Third Embodiment

### System Configuration

Referring to FIG. 5 again, in the present embodiment, the client device 350 transmits (uploads) the video information to the server 400. The transmitted information is stored in the recording device of the server 400. The video information stored in the server 400 is transmitted (distributed) to the client device 360 according to the demand from the device 360.

Since the configuration of the client device 350 and 360 of present embodiment is same as that of the second embodiment, a detailed explanation is omitted here. On the other hand, the configuration of the server 400 is different from the server 300 of the second embodiment. While a bit rate control is performed when recording to the recording medium 48 in the server 300, the bit rate control is performed when playing back a data from the medium 48 in the server 400. Hereafter, the configuration of the server 400 is explained.

### (Configuration of Server 400)

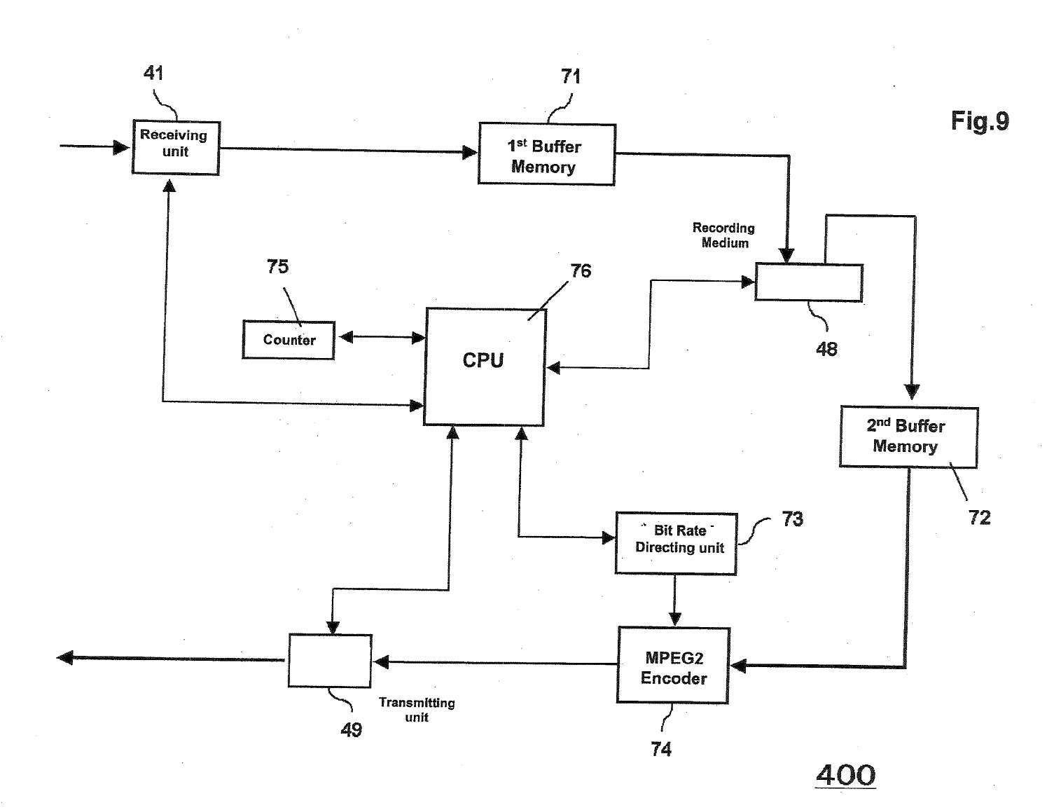

Referring to FIG. 9, the server 400 has a receiving unit 41, a first buffer memory 71, a recording medium 48, a second buffer memory 72, a bit rate directing unit 73, a MPEG-2 encoder 74, a counter 75, a CPU 76, and a transmitting unit 49.

The receiving unit 41 receives video information etc. from networks such as Ethernet as well as the server 300 of the second embodiment. The following explanation is given, assuming that the unit 41 receives video signal encoded in MPEG-2 format by the client device 350.

The first buffer memory 71 is a semiconductor memory prepared between the receiving unit 41 and the recording medium 48, which stores data temporarily in order to compensate the difference between the receiving speed of the unit 41, and the recording speed to the medium 48.

The second buffer memory 72 is a semiconductor memory prepared between the recording medium 48 and the MPEG-2 encoder 74, which stores data temporarily in order to compensate the difference between the reading speed from the medium 48, and the encoding speed of the encoder 48.

The bit rate directing unit 73 directs the MPEG-2 encoder 74 to change the bit rate. The encoder 74 changes the bit rate of the video signal read from the recording medium 48 according to the direction from the unit 73. The transmitting unit 49 transmits the video signal, in which the bit rate is converted in the encoder 74, to network.

The counter 75 measures time. For example, it measures the time elapsed since the beginning time of video information read-out from the recording medium 48.

CPU 47 performs a process such as recognizing the receiving unit 41 receiving video information signals, controlling the bit rate directing unit 73 and the counter 75, or controlling each part of the server 400.

The MPEG-2 encoder 74 may decode whole video information (contents) (i.e. perform a “full decoding”) and then re-encode the information, or it may trans-rate without the full-decoding of the information, or it may trans-code the information to the other encoding formats.

### (Upload Process)

Here, an example of uploading process of video information to the server 400 from the client device 350 is explained.

When a user of the client device 350 uploads video information to the server 400, the user instructs from the directing unit 53 to transmit the information to the server 400. The video information transmitted from the client 350 is stored in the recording medium 48 of the server 400.

### (Distribution Process)

Here, an example of process distributing video information stored in the server 400 to the client device 360, and playing back the video information by the device 360 is explained.

Since the process which the client device 360 acquires a list of the video information the server 400 currently stores and the process which the device 360 specifies the demanding video information are similar to the second embodiment, a detailed explanation is omitted.

When the receiving unit 41 of the server 400 receives a distribution demanding signal from the client device 360, the CPU 76 controls so that the demanded video information is read out from the recording medium 48. The bit rate directing unit 73 directs to the MPEG-2 encoder 74 to convert the bit rate of the video information read out from the medium 48 to the second bit rate, during a period right after receiving the demanding signal from the client 360. When the amount of the data read out from the medium 48 reached the predetermined amount, the unit 73 directs the encoder 74 to convert the rate to the first bit rate which is a predetermined rate. The video information in which the bit rate is changed by the encoder 74 is transmitted to the device 360, and then is output to the video output unit 65 of the device 360 as well as in the second embodiment.

As mentioned above, the server 400 distributes video information in the bit rate higher than the predetermined bit rate at the beginning. Thereby, the client device 360 can reproduce video information shortly after the video information demand to the server 400.

Further, according to a method which converts bit rate after reading data from the recording medium, such as achieved in the server 400, it is effective when the client device demands a reproduction of the content from the mid-stream, instead of from the beginning of the content.

### Fourth Embodiment

### System Configuration

Referring to FIG. 5 again, the client device 550 transmits (uploads) video information to the server 500 in this embodiment. The information transmitted is stored in the recording device of the server 500. The stored information in the server 500 is transmitted (distributed) to the client device 360 according to the demand from the device 360. Thus, in the present embodiment, instead of the client device controlling bit rate in the server, the client device which uploads the video information controls the bit rate.

Since the configuration of the client device 360 of present embodiment is same as that of the second or the third embodiment, a detailed explanation is omitted. On the other hand, the configuration of the client device 550 and the server 500 are different from those of the client device 350 and server 400 of the second embodiment.

### (Configuration of Client Device 550)

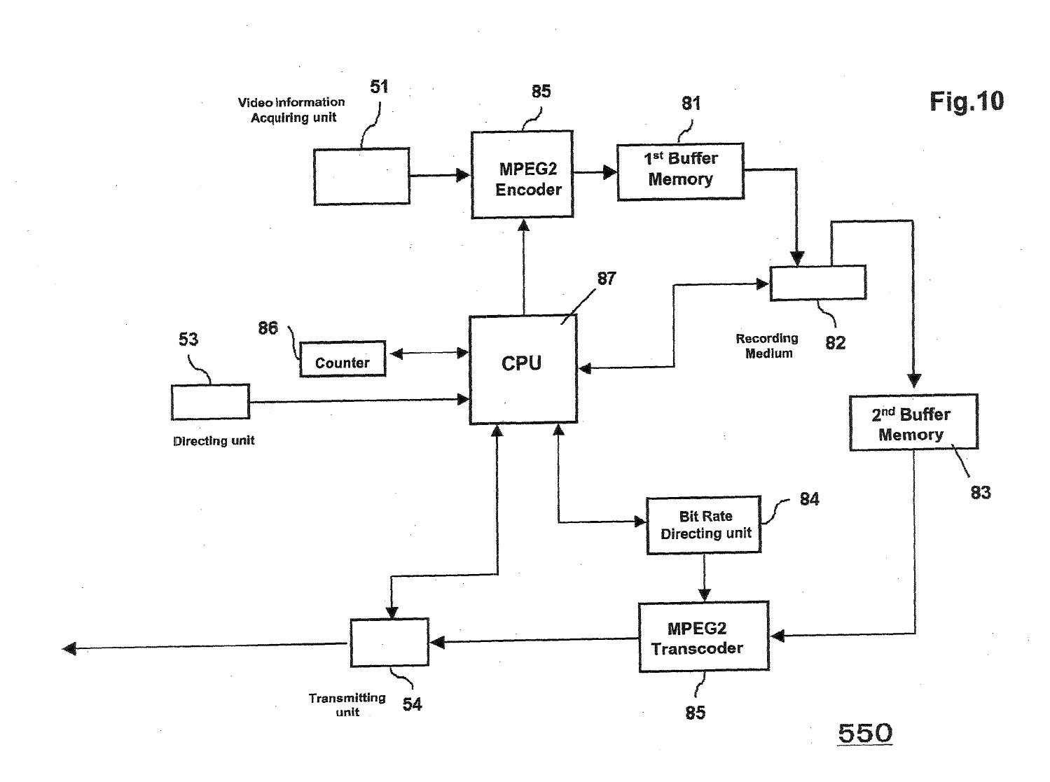

Referring to FIG. 10, the client device 550 has video information acquiring unit 51, a first buffer memory 81, a recording medium 82, a second buffer memory 83, a bit rate directing unit 84, a MPEG-2 encoder 85, a counter 86, a CPU 87, a directing unit 53, and a transmitting unit 54. Since the configuration of the unit 51 and 53 are same as that of the client device 350 of the second or the third embodiment, the explanation is omitted.

The first buffer memory 81 is a semiconductor memory prepared between the unit 51 and the medium 82, and stores data temporarily in order to compensate the difference of the processing speed of the unit 51 and the recording speed to the medium 82.

The recording medium 82 is a medium, such as hard disk, DVD, or semiconductor memory. The second buffer memory 83 is a semiconductor memory prepared between the medium 82 and the MPEG-2 encoder 85 and the memory 83 stores data temporarily in order to compensate the difference of the read out speed from the medium 82, and the processing speed of the encoder 85.

The bit rate directing unit 84 instructs the encoder 85 to change bit rate. The encoder 85 changes the bit rate of the video signal read out from the medium 82 according to the instruction from the unit 84. The transmitting unit 54 transmits a video signal, in which the bit rate is converted in the encoder 85, to the network.

The counter 86 measures time. For example, it measures the time elapsed since the beginning time of video information read-out from the recording medium 82.

CPU 87 performs a process such as recognizing the receiving unit 51 receiving video information signals, controlling the bit rate directing unit 84 and the counter 86, or controlling each part of the client device 550.

### (Configuration of Server 500)

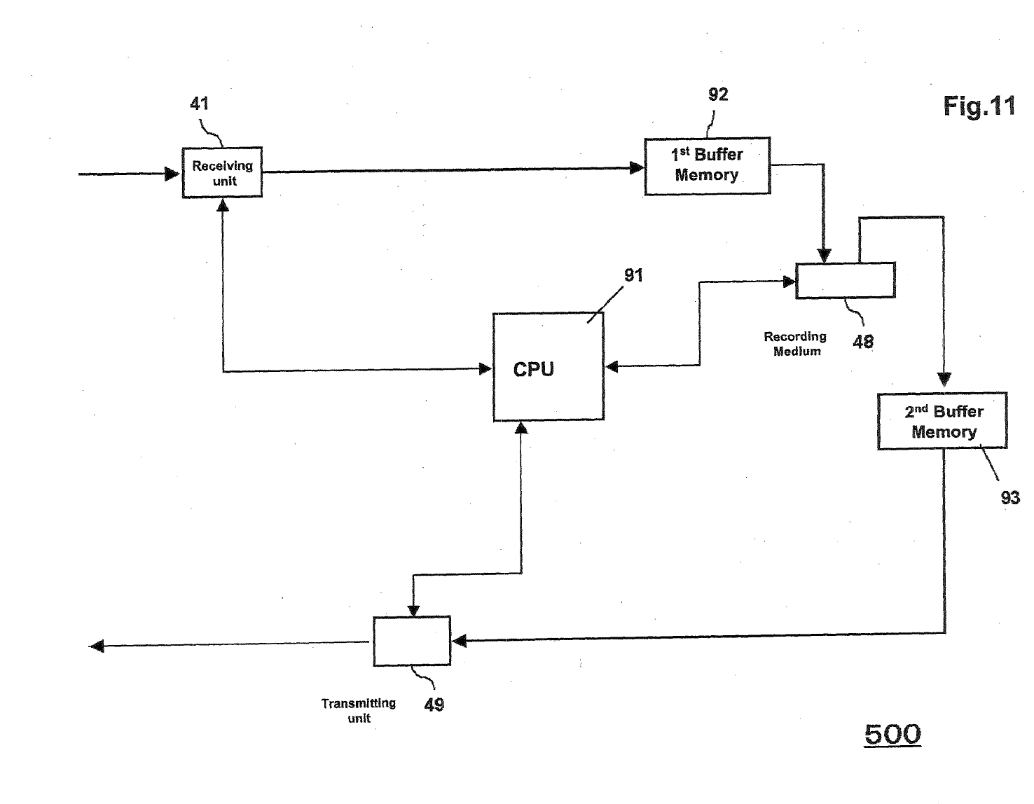

Referring to FIG. 11, the server 500 has a receiving unit 41, a first buffer memory 92, a recording medium 48, a second buffer memory 93, a CPU 91, and a transmitting unit 49. The configuration of the units 41 and 49 and medium 48 are same as that of the server 300 of the second embodiment or the server 400 of the third embodiment. The configuration of the second buffer memory 93 is same as that of the server 300.

### (Upload Process)

Here, an example of uploading process of video information to the server 500 from the client device 550 is explained.

When a user of the client device 550 uploads video information stored in the recording medium 82 of the device 550 to the server 400, the user instructs from the directions unit 53 to transmit the information to the server 400.

Receiving this instruction, the CPU 87 read out the video information which is instructed, and simultaneously transmit a direction to the bit rate directing unit 84. The unit 84 controls the MPEG-2 encoder 85 to transmit to the second bit rate which is higher than the predetermined bit rate at the beginning of the read out. When the amount of read-out data reached predetermined amount, the CPU 87 directs the encoder 85 to converts to the first bit rate which is a predetermined rate. The video information, in which a bit rate is converted, is transmitted to the server 500. Then the video information transmitted from the client 550 is stored in the recording medium 48 of the server 500.

### (Distribution Process)

The video information stored in the server 500 is distributed to the client device 360, and then the information is reproduced in the device 360. Since the process the client device 360 acquiring the list of the video information the server 500 stores and the process specifying the demanding video information is similar to the second or the third embodiment, the explanation is omitted.

When the receiving unit 41 of the server 500 receives the demanding signal from the device 360, the CPU 91 controls so that the demanded video information is read from the recording medium 48. The video information read out is transmitted to the device 360 and output to the video output unit 65 as well as the second or the third embodiment.

As mentioned above, in the client device 550, it transmits the video information in a high bit rate, which is higher than the predetermined rate, in the beginning portion of the uploading process. As a result, the client device 360 can reproduce video information shortly after demanding the video information to the server 500.

### (Modification)

The client device 550 may change bit rate during the recording to the recording medium 82, instead of changing the rate during the uploading process to the server. The client device 360 can reproduce video information shortly after demanding the video information to the server 500 as well as in this modification.

The present invention is not limited to the foregoing embodiment but can be modified variously by one skilled in the art without departing from the spirit of the invention as set forth in the appended claims.

1. A video recording and playback device simultaneously executing a recording process which encodes video information and records to a recording medium, and a playback process which decodes the video information and reproduces the information, comprising:
an encoding processing unit encoding the video information to be recorded on the recording medium; and
a bit rate directing unit instructing the encoding bit rate of the video information as a first bit rate, wherein
the encoding processing unit encodes the information in the second bit rate which is higher than the first bit rate, before encoding the information in the first bit rate.

2. The device of claim 1, further comprises:
a recorded amount monitoring unit monitoring the video information data capacity recorded to the recording medium from the time point receiving an instruction to record the video information to the recording medium, and
the encoding processing unit switches the encoding bit rate of the video data from the second bit rate to the first bit rate when the data capacity monitored by the monitoring unit reaches the predetermined amount.

3. The device of claim 1, further comprises:
a time measuring unit measuring the time from the time point receiving an instruction to record the video information to the recording medium, and
the encoding processing unit switches the encoding bit rate of the video data from the second bit rate to the first bit rate when the time measured by the time measuring unit reaches the predetermined time.

4. The device of claim 2, wherein
the encoding processing unit switches the encoding bit rate of the video data to the first bit rate by gradually decreasing it from the second bit rate.

5. The device of claim 3, wherein
the encoding processing unit switches the encoding bit rate of the video data to the first bit rate by gradually decreasing it from the second bit rate.

6. A video encoding device executing a process which encodes video information recorded on a recording medium, comprising:
an encoding processing unit encoding the video information read out from the recording medium; and
a bit rate directing unit instructing the bit rate, when playing back the video information, as a first bit rate, wherein
the encoding processing unit encodes the video data in the second bit rate which is higher than the first bit rate data, before encoding the video data in the first bit rate.

7. A video encoding device executing a process which encodes video information and records to a recording medium, comprising:
an encoding processing unit encoding the video information; and
a bit rate directing unit instructing the bit rate of the video information, when recording to the recording medium, as a first bit rate, wherein
the encoding processing unit encodes the video data in the second bit rate which is higher than the first bit rate data before encoding the data in the first bit rate.
